(19) United States
(12) Patent Application Publication
(10) Pub. No.: US 2006/0148358 A1
(43) Pub. Date: Jul. 6, 2006

(54) Elastic laminate and process therefor

(76) Inventors: Gregory K. Hall, Menasha, WI (US); David Glenn Biggs, Neenah, WI (US); Darin Allen Engelhart, Appleton, WI (US); Thomas Kremer, Appleton, WI (US); Peiguang Zhou, Appleton, WI (US)

Correspondence Address: KIMBERLY-CLARK WORLDWIDE, INC., 401 NORTH LAKE STREET, NEENAH, WI, 54956, US

(21) Appl. No.: 11/026,245

(22) Filed: Dec. 30, 2004

(51) Int. Cl. B32B 5/26; B32B 37/00; B32B 27/12

(52) U.S. Cl. 442/328; 156/160; 156/161; 156/163; 156/164; 156/229; 442/329; 442/381; 442/382; 442/394

(57) ABSTRACT

Disclosed herein are elastic laminate materials having an elastic member and at least one fibrous nonwoven web. The elastic laminate materials have highly desirably properties of extensibility and elastic recovery, and cloth-like aesthetic properties of softness and drapability. In embodiments, the elastic laminate materials may include a second fibrous nonwoven web bonded to the opposite side of the elastic member. Also disclosed herein is a process for forming the elastic laminate materials. Such elastic laminate materials are highly useful for components in or on personal care products, protective wear garments, medical care products, bandages and the like.

### BACKGROUND OF THE INVENTION

Many of the medical care products, protective wear garments, mortuary and veterinary products, and personal care products in use today are available as disposable products. By disposable, it is meant that the product is used only a few times, or even only once, before being discarded. Examples of such products include, but are not limited to, medical and health care products such as surgical drapes, gowns and bandages, protective workwear garments such as coveralls and lab coats, and infant, child and adult personal care absorbent products such as diapers, training pants, incontinence garments and pads, sanitary napkins, wipes and the like. These products need to be manufactured at a cost which is consistent with single- or limited-use disposability.

Fibrous nonwoven webs formed by extrusion processes such as spunbonding and meltblowing, and by mechanical dry-forming processes such as air-laying and carding, used in combination with thermoplastic film or microfiber layers, may be utilized as components of these disposable products since their manufacture is often inexpensive relative to the cost of woven or knitted components. An elastic layer (elastic film, strands, fibers or fibrous webs, for example) may be used to impart additional properties of stretch and recovery. However, films in general and elastic layers in particular, whether a film layer or fibrous, often have unpleasant tactile aesthetic properties, such as feeling rubbery or tacky to the touch, making them unpleasant and uncomfortable against the wearer's skin. Fibrous nonwoven webs, on the other hand, have better tactile, comfort and aesthetic properties.

The tactile aesthetic properties of elastic members can be improved by forming a laminate of an elastic with one or more fibrous nonwoven facing webs. However, fibrous nonwoven webs formed from non-elastic polymers such as, for example, polyolefins are generally considered non-elastic and may have poor extensibility, and when non-elastic nonwoven webs are laminated to elastic materials the resulting laminate may also be restricted in its elastic properties. Therefore, laminates of elastic materials with nonwoven webs have been developed wherein the nonwoven webs are made extensible by processes such as necking or gathering.

However, since these elastic/nonwoven laminate materials are often utilized in limited- or single-use disposable products, there remains a strong need for elastic materials having improved cloth-like attributes, and for reducing the cost of producing soft, cloth-like elastic materials.

### SUMMARY OF THE INVENTION

The present invention provides a process for producing elastic laminate materials that are highly suited for use in or as one or more components of disposable products. In one aspect, the process for producing the elastic laminate material includes the steps of providing at least one elastic member and at least one fibrous nonwoven web material, extending the fibrous nonwoven web in at least one direction in an extension amount sufficient to permanently elongate the fibrous nonwoven web, the at least one direction selected from the machine direction and the cross machine direction, applying an extending force in the machine direction to the elastic member to extend the elastic member in the machine direction, interposing the elastic member and the fibrous nonwoven web in a face-to-face relation, and then bonding the elastic member and fibrous nonwoven web together to form a laminate material. In embodiments, the process may include the further steps of providing a second fibrous nonwoven web and interposing the second fibrous nonwoven web in a face-to-face relation with the elastic member, on the side of the elastic member that is opposite the at least one fibrous nonwoven web. The second fibrous nonwoven web may also be subject to extension in the machine or cross machine direction prior to being interposed with the elastic member.

In another aspect, the process for producing the elastic laminate material includes the steps of providing an elastic member that includes substantially parallel elastic strand arrangements, providing at least one fibrous nonwoven web material, applying an extending force in the machine direction to the elastic member to extend the elastic member in the machine direction, interposing the elastic member and the fibrous nonwoven web in a face-to-face relation, bonding the elastic member and the fibrous nonwoven web together to form a laminate material, and then extending the laminate material in at least one direction in an extension amount sufficient to permanently elongate the fibrous nonwoven web, the direction selected from the machine direction and the cross machine direction. In embodiments, the extension amount is at least 115 percent of the unstretched laminate length or dimension. In embodiments, the elastic member strands may be adhesively bonded to the fibrous nonwoven web material, and in embodiments, the process may include the further steps of providing a second fibrous nonwoven web, interposing the second fibrous nonwoven web in a face-to-face relation with the elastic member on the side of the elastic member opposite the at least one fibrous nonwoven web, and bonding the at least one fibrous nonwoven web, the elastic member and the second fibrous web together to form a laminate material.

The present invention further provides elastic laminate materials such as may be made by the process embodiments described above. In embodiments, the elastic laminate material may desirably include at least one elastic member and at least one fibrous nonwoven web bonded together in face-to-face relation, the fibrous nonwoven web having on at least one surface thereof a short open time reinforcement adhesive in an amount less than about 10 grams per square meter. In embodiments, the elastic member may desirably be such as elastic meltblown, elastic strands and elastic films, and in embodiments, the at least one fibrous nonwoven web may desirably be such as spunbond webs, spunbond-meltblown webs, spunbond-meltblown-spunbond webs and carded webs.

### BRIEF DESCRIPTION OF THE DRAWINGS

FIG. 1 schematically illustrates an embodiment of the process for forming the elastic laminate material.

FIG. 2 schematically illustrates a unit for providing extension to a material.

FIG. 3 schematically illustrates another embodiment of the process for forming the elastic laminate material.

FIG. 4 and FIG. 5 are micrographs of a comparative elastic material.

FIGS. 6-9 are micrographs of an elastic laminate material of the invention.

### DEFINITIONS

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries. As used herein the term “thermoplastic” or “thermoplastic polymer” refers to polymers that will soften and flow or melt when heat and/or pressure are applied, the changes being reversible.

As used herein, the terms “elastic” and “elastomeric” are generally used to refer to a material that, upon application of a force, is stretchable to a stretched, biased length which is at least about 133 percent, or one and a third times, its relaxed, unstretched length or dimension, and which upon release of the stretching, biasing force will recover at least about 50 percent of its elongation. By way of example only, an elastic material having a relaxed, unstretched length or dimension of 10 centimeters may be elongated to at least about 13.3 centimeters by the application of a stretching or biasing force. Upon release of the stretching or biasing force the elastic material will recover to a length of not more than 11.65 centimeters.

As used herein the term “fibers” refers to both staple length fibers and substantially continuous filaments, unless otherwise indicated. As used herein the term “substantially continuous” with respect to a filament or fiber means a filament or fiber having a length much greater than its diameter, for example having a length to diameter ratio in excess of about 15,000 to 1, and desirably in excess of 50,000 to 1.

As used herein the term “monocomponent” fiber refers to a fiber formed from one or more extruders using only one polymer composition. This is not meant to exclude fibers or filaments formed from one polymeric extrudate to which small amounts of additives have been added for color, anti-static properties, lubrication, hydrophilicity, etc.

As used herein the term “multicomponent fibers” refers to fibers or filaments that have been formed from at least two component polymers, or the same polymer with different properties or additives, extruded from separate extruders but spun together to form one fiber or filament. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a concentric or eccentric sheath/core arrangement wherein one polymer is surrounded by another, or may be a side by side arrangement, an “islands-in-the-sea” arrangement, or arranged as pie-wedge shapes or as stripes on a round, oval or rectangular cross-section fiber, or other configurations. Multicomponent fibers are taught in U.S. Pat. No. 5,108,820 to Kaneko et al. and U.S. Pat. No. 5,336,552 to Strack et al. Conjugate fibers are also taught in U.S. Pat. No. 5,382,400 to Pike et al. and may be used to produced crimp in the fibers by using the differential rates of expansion and contraction of the two (or more) polymers. For two component fibers, the polymers may be present in ratios of 75/25, 50/50, 25/75 or any other desired ratios. In addition, any given component of a multicomponent fiber may desirably comprise two or more polymers as a multiconstituent blend component.

As used herein the terms “biconstituent fiber” or “multiconstituent fiber” refer to a fiber or filament formed from at least two polymers, or the same polymer with different properties or additives, extruded from the same extruder as a blend. Multiconstituent fibers do not have the polymer components arranged in substantially constantly positioned distinct zones across the cross-section of the multicomponent fibers; the polymer components may form fibrils or protofibrils that start and end at random.

As used herein the terms “nonwoven web” or “nonwoven fabric” refer to a web having a structure of individual fibers or filaments that are interlaid, but not in an identifiable manner as in a knitted or woven fabric. Nonwoven fabrics or webs have been formed from many processes such as for example, meltblowing processes, spunbonding processes, airlaying processes, and carded web processes. The basis weight of nonwoven fabrics is usually expressed in grams per square meter (gsm) or ounces of material per square yard (osy) and the filament diameters useful are usually expressed in microns. (Note that to convert from osy to gsm, multiply osy by 33.91).

The terms “spunbond” or “spunbond nonwoven web” refer to a nonwoven fiber or filament material of small diameter fibers that are formed by extruding molten thermoplastic polymer as fibers from a plurality of capillaries of a spinneret. The extruded fibers are cooled while being drawn by an eductive or other well known drawing mechanism. The drawn fibers are deposited or laid onto a forming surface in a generally random manner to form a loosely entangled fiber web, and then the laid fiber web is subjected to a bonding process to impart physical integrity and dimensional stability. The production of spunbond fabrics is disclosed, for example, in U.S. Pat. No. 4,340,563 to Appel et al., U.S. Pat. No. 3,692,618 to Dorschner et al., and U.S. Pat. No. 3,802,817 to Matsuki et al., all incorporated herein by reference in their entireties. Typically, spunbond fibers or filaments have a weight-per-unit-length in excess of about 1 denier and up to about 6 denier or higher, although both finer and heavier spunbond fibers can be produced. In terms of fiber diameter, spunbond fibers often have an average diameter of larger than 7 microns, and more particularly between about 10 and about 25 microns, and up to about 30 microns or more.

As used herein the term “meltblown fibers” means fibers or microfibers formed by extruding a molten thermoplastic material through a plurality of fine, usually circular, die capillaries as molten threads or filaments or fibers into converging high velocity gas (e.g. air) streams that attenuate the fibers of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be substantially continuous or discontinuous, are often smaller than 10 microns in average diameter and are frequently smaller than 7 or even 5 microns in average diameter, and are generally tacky when deposited onto a collecting surface.

As used herein “carded webs” refers to nonwoven webs formed by carding processes as are known to those skilled in the art and further described, for example, in U.S. Pat. No. 4,488,928 to Alikhan and Schmidt which is incorporated herein in its entirety by reference. Briefly, carding processes involve starting with staple fibers in a bulky batt that is combed or otherwise treated to provide a web of generally uniform basis weight. Typically, the webs are thereafter bonded by such means as through-air bonding, thermal point bonding, adhesive bonding, and the like.

As used herein, “thermal point bonding” involves passing a fabric or web of fibers or other sheet layer material to be bonded between a heated calender roll and an anvil roll. The calender roll is usually, though not always, patterned on its surface in some way so that the entire fabric is not bonded across its entire surface. As a result, various patterns for calender rolls have been developed for functional as well as aesthetic reasons. One example of a pattern has points and is the Hansen Pennings or “H&P” pattern with about a 30 percent bond area with about 200 bonds per square inch (about 31 bonds per square centimeter) as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen and Pennings or “EHP” bond pattern which produces a 15 percent bond area with a square pin having a side dimension of 0.037 inches (0.94 mm), a pin spacing of 0.097 inches (2.464 mm) and a depth of 0.039 inches (0.991 mm). Other common patterns include a high density diamond or “HDD pattern”, which comprises point bonds having about 460 pins per square inch (about 71 pins per square centimeter) for a bond area of about 15 percent to about 23 percent, a “Ramish” diamond pattern with repeating diamonds having a bond area of about 8 percent to about 14 percent and about 52 pins per square inch (about 8 pins per square centimeter) and a wire weave pattern looking as the name suggests, e.g. like a window screen. As still another example, the nonwoven web may be bonded with a point bonding method wherein the arrangement of the bond elements or bonding “pins” are arranged such that the pin elements have a greater dimension in the machine direction than in the cross-machine direction. Linear or rectangular-shaped pin elements with the major axis aligned substantially in the machine direction are examples of this. Alternatively, or in addition, useful bonding patterns may have pin elements arranged so as to leave machine direction running “lanes” or lines of unbonded or substantially unbonded regions running in the machine direction, so that the nonwoven web material has additional give or extensibility in the cross machine direction. Such bonding patterns as are described in U.S. Pat. No. 5,620,779 to Levy et al., incorporated herein by reference in its entirety, may be useful, such as for example the “rib-knit” bonding pattern therein described. Typically, the percent bonding area varies from around 10 percent to around 30 percent or more of the area of the fabric or web. Thermal bonding imparts integrity to individual layers or webs by bonding fibers within the layer and/or for laminates of multiple layers, such thermal bonding holds the layers together to form a cohesive laminate material.

### DETAILED DESCRIPTION OF THE INVENTION

The present invention provides a process for producing elastic laminate materials including at least one elastic member and at least one fibrous nonwoven web. The elastic laminate materials have highly desirable clothlike aesthetics of softness and surface fuzziness, hand and drape, in addition to the desirable elastic properties of stretchability, i.e. extensibility with recovery. The elastic laminate materials are suitable for use in a wide range of personal care products, medical products and garments, and the like, wherever a soft, cloth-like elastic material is desired.

The invention will be described with reference to the following description and figures which illustrate certain embodiments. It will be apparent to those skilled in the art that these embodiments do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and equivalents.

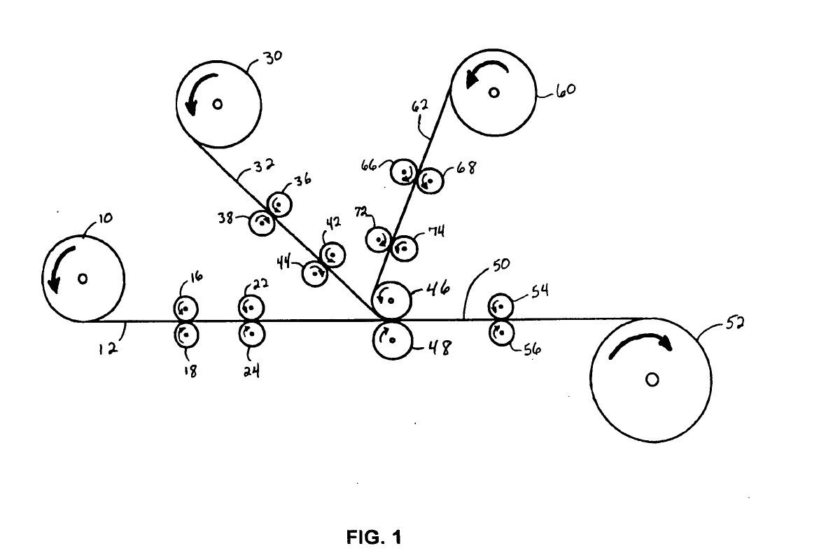

Turning to FIG. 1, there is illustrated schematically an embodiment of the process of the invention. In the process shown, a first fibrous nonwoven web 12 is provided by unwinding the fibrous nonwoven web 12 from material unwind roll 10. The fibrous nonwoven web 12 is directed through an extending station which includes first pair of nipped driven rollers 16, 18 and second pair of nipped driven rollers 22, 24. The first pair of nipped rollers 16, 18 is rotating at a first linear or peripheral velocity and the second pair of nipped rollers 22, 24 is rotating at a second linear velocity which is greater than the first linear velocity at first nipped rollers 16, 18. Because the second pair of nipped rollers 22, 24 draw the fibrous nonwoven web 12 at a higher linear velocity than first pair of nipped rollers 16, 18, the fibrous nonwoven web 12 experiences a machine direction tensioning force which extends the fibrous nonwoven web 12 in the machine direction.

Desirably, the fibrous nonwoven web 12 may be extended to at least about 105 percent of its original length. Depending on the desired level of cloth-like attributes and desired ease of extensibility in the final elastic laminate material product, the fibrous nonwoven web 12 may desirably be extended to at least about 110 percent, 115 percent, 120 percent, or more of its original length. It should be noted that attempting to measure the amount of extension applied to a moving web may be difficult. Therefore, for extension through pairs of differential velocity nipped rollers, the level of extension may be considered as equivalent to the linear velocity ratio of the pairs of rollers. As an example, where the first pair of nipped rollers 16, 18 is rotating at a first linear velocity of 50 meters per minute, and the second pair of nipped rollers 22, 24 is rotating at a second linear velocity of 60 meters per minute, the second pair of rollers has a linear velocity which is 120 percent of the first pair of rollers.

The fibrous nonwoven web may desirably be fibrous nonwovens as are known in the art, such as spunbonded nonwoven webs, carded nonwoven webs, meltblown nonwoven webs, and laminate web materials such as the spunbond-meltblown and spunbond-meltblown-spunbond laminates such as are described in U.S. Pat. Nos. 4,041,203 and 4,766,029 to Brock et al. and U.S. Pat. No. 5,169,706 to Collier et al., all of which are incorporated herein by reference in their entireties. Generally speaking, the basis weight of the fibrous nonwoven may suitably be from about 7 gsm or less up to 100 gsm or more, and more particularly the fibrous nonwoven web may have a basis weight from about 10 gsm or less to about 68 gsm, and still more particularly, from about 14 gsm to about 34 gsm. Other examples are possible. In addition, the fibrous nonwoven web is not limited to any particular fiber type or types and so may be made from or include multiconstituent fibers as are known in the art and/or multicomponent fibers such as may be produced as disclosed in U.S. Pat. No. 5,382,400 to Pike et al., incorporated herein by reference in its entirety, wherein a heat treatment may be used to activate latent helical crimp in multicomponent fibers before the fibers have been formed into a nonwoven web. As an alternative to multicomponent fibers, fiber crimp may be produced in homofilament or monocomponent fibers (fibers having one polymer component) by utilizing the teachings disclosed in U.S. Pat. No. 6,632,386 to Shelley et al., U.S. Pat. No. 6,446,691 to Maldonado et al. and U.S. Pat. No. 6,619,947 to Pike et. al., all incorporated herein by reference in their entireties.

Polymers suitable for making the fibrous nonwoven webs to be used in the embodiments described herein include those polymers known to be generally suitable for making nonwoven webs such as spunbond, meltblown, carded webs and the like, and include for example polyolefins, polyesters, polyamides, polycarbonates and copolymers and blends thereof. It should be noted that the polymer or polymers may desirably contain other additives such as processing aids or treatment compositions to impart desired properties to the fibers, residual amounts of solvents, pigments or colorants and the like.

Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include poly(lactide) and poly(lactic acid)polymers as well as polyethylene terephthalate, polybutylene terephthalate, polytetramethylene terephthalate, polycyclohexylene-1,4-dimethylene terephthalate, and isophthalate copolymers thereof, as well as blends thereof.

Returning to FIG. 1, while fibrous nonwoven web 12 is being unwound from material unwind 10 and extended, the elastic member 32 is being unwound from material unwind roll 30. The elastic member 32 is also directed through an elastic extending station which includes third pair of nipped driven rollers 36, 38 and fourth pair of nipped driven rollers 42, 44. As with the fibrous nonwoven web, for the elastic member 32 the third pair of nipped rollers is rotating at a third linear or peripheral velocity and the fourth pair of nipped rollers 42, 44 is rotating at a fourth linear velocity which is greater than the third linear velocity at third nipped rollers 36, 38, in order to apply a machine direction tensioning force draw or extend the elastic member 32 in the machine direction. The elastic member 32 may be extended to at least about 150 percent of its original length. As stated above, an elastic material is a material that, upon application of a force, is stretchable to a stretched, biased length which is at least about 133 percent, or one and a third times, its relaxed, unstretched length or dimension, and which upon release of the stretching, biasing force will recover at least about 50 percent of its elongation. Desirably, a suitable elastic material will have more stretch and recovery properties than the minimum stated. For example, desirable levels of stretchability may be at least about 200 percent, 300 percent, 400 percent, or more of the material's unstretched dimension, and elastic materials having desirable levels of recovery may exhibit at least about 60 percent, 70 percent, 80 percent, 90 percent, or more of elongation recovery.

Returning to FIG. 1, depending on the desired level of extensibility and elasticity in the final elastic laminate material product, and depending on the overall elastic extensibility properties of the elastic member, the elastic member 32 may desirably be extended to at least about 200 percent, 300 percent, 400 percent, 500 percent, or even 600 percent or more, of its original length. Generally, the elastic member 32 will be extended at a much higher percentage than the percentage extension of the fibrous nonwoven web 12. It should be noted, however, that whatever the relative levels of extension for elastic member 32 an fibrous nonwoven web 12, the linear velocity at second pair of nipped rollers 22, 24 and fourth pair of nipped rollers 42, 44 should be equal or nearly equal, so that the two materials are fed into the nip formed between laminating rollers 46, 48 at substantially equal rates of speed.

The elastic member 32 may desirably be selected from any suitable elastic materials as are known in the art to be capable of providing elastic extensibility with recovery. Such suitable elastic materials include elastic films, elastic strands and elastic nonwoven webs such as elastic spunbond webs and elastic meltblown webs. It should be noted that when an elastic film is selected for the elastic member, it may be highly desirable to produce the elastic film directly in-process rather than unwinding a previously produced film from material unwind 30. In that case, material unwind roll 30 would be replaced with an elastic film die being fed a molten elastic thermoplastic polymeric composition from an extruder, and the newly formed elastic film would typically travel over one or more chilled rollers to quench it from the molten state prior to the stretching step. In a similar fashion, where a meltblown nonwoven web or spunbond nonwoven web elastic member is selected, the nonwoven web could be directed from a nearby or in-line nonwoven production line and straightaway into the process line shown in FIG. 1, rather than being stored and unwound from material unwind 30.

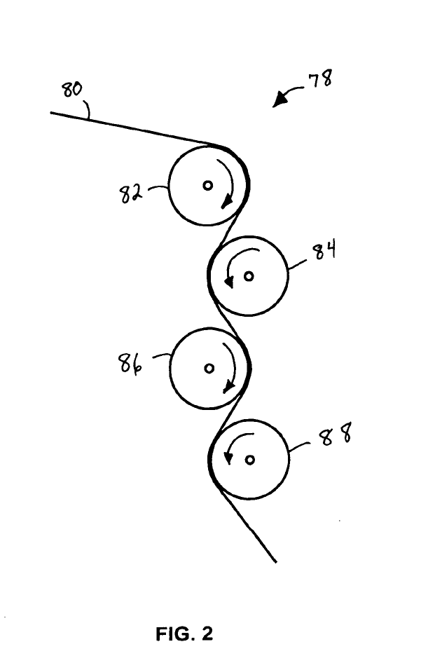

An alternative method for extending the elastic member 32 (which would optionally replace roller pairs 36, 38 and 42, 44) is referred to as a “machine direction orienter” or MDO unit. A MDO unit is an assembly of (generally) non-nipped rollers arranged in a substantially vertical stack, and, although not required, typically are arranged with each next lower roller offset horizontally somewhat from the next higher roller, such that the rollers are not arranged in a straight vertical line. The material to be extended travels through the roller stack in an alternating or “S” wrap or “serpentine” wrap fashion, such that the material contacts a first driven roller with one planar material surface, a second driven roller with the opposite planar material surface, a third roller with the first material surface again, and so on. Each subsequent driven roller may be driven at a speed slightly higher than the previous roller. An exemplary MDO unit 78 is illustrated in side view in FIG. 2, showing the travel path of a material 80 through driven rollers 82, 84, 86 and 88. For the exemplary MDO unit 78 illustrated in FIG. 2, the material 80 enters the MDO 78 from a material unwind or other source (not shown), and, traveling downwardly through the MDO 78, contacts the slowest driven roller 82 first and then each next faster driven roller 84, 86 and 88, and exits the MDO 78 after roller 88. As a specific example, if material 80 enters the unit at a linear velocity of about 100 meters per minute, and if roller 82 has a linear velocity 10 percent greater than the initial velocity of the material, and each roller thereafter a 10 percent greater linear velocity than the previous roller, then roller 88 (and the material 80, after it exits roller 88) would be expected to have a linear velocity of about 146 meters per minute. This would represent a material extension level of about 146 percent. One skilled in the art will appreciate that the relative spacing, both lateral and vertical, between the rollers shown in FIG. 2 is exemplary only and that the spacings may be adjusted as desired. As an example, the lateral spacings between subsequent rollers may be greater or lesser than shown, such that the material passing between the rollers wraps each roller to a lesser or greater extent, respectively.

Generally, the basis weight of the elastic member in the elastic laminate material may be from about 5 gsm or less to about 100 gsm or greater. More particularly, the elastic member may have a basis weight from about 5 gsm to about 68 gsm, and still more particularly from about 5 gsm to about 34 gsm. Because elastic materials are often expensive to produce, the basis weight of elastic material utilized is desirably of as low a basis weight as is possible while still providing the desired properties of stretch and recovery to the elastic laminate material.

When the elastic member 32 is an elastic film layer, it may be desirable for the film to be breathable. Meltblown and spunbond layers are inherently breathable; that is, meltblown and spunbond layers are capable of transmitting gases and water vapors. Film layers however, generally act as a barrier to the passage of liquids, vapors and gases. An elastic layer which is breathable may provide increased in-use comfort to a wearer by allowing passage of water vapor and assist in reducing excessive skin hydration, and help to provide a more cool feeling. Therefore, where a film is used as the elastic member but a breathable elastic laminate is desired, the elastic material used may be a breathable monolithic or microporous barrier film.

Monolithic breathable films can exhibit breathability when they comprise polymers which inherently have good water vapor transmission or diffusion rates such as, for example, polyurethanes, polyether esters, polyether amides, EMA, EEA, EVA and the like. Examples of elastic breathable monolithic films are described in U.S. Pat. No. 6,245,401 to Ying et al., incorporated herein by reference in its entirety, and include those comprising polymers such as thermoplastic (ether or ester) polyurethane, polyether block amides, and polyether esters. Microporous breathable films contain a filler material, such as for example calcium carbonate particles, in an amount usually from about 30 percent to 70 percent by weight of the film. The filler-containing film (or “filled film”) opens micro-voids around the filler particles when the film is stretched, which micro-voids allow for the passage of air and water vapor through the film. Breathable microporous elastic films containing fillers are described in, for example, U.S. Pat. Nos. 6,015,764 and 6,111,163 to McCormack and Haffner, U.S. Pat. No. 5,932,497 to Morman and Milicevic, and in U.S. Pat. No. 6,461,457 to Taylor and Martin, all incorporated herein by reference in their entireties. Another example of a film which can exhibit breathability is a cellular elastic film, such as may be produced by mixing an elastic polymer resin with a cell opening agent which decomposes or reacts to release a gas that forms cells in the elastic film. The cell opening agent can be an azodicarbonamide, fluorocarbons, low boiling point solvents such as for example methylene chloride, water, or other agents such as are known to those skilled in the art to be cell opening or blowing agents which will create a vapor at the temperature experienced in the film die extrusion process. Cellular elastic films are described in PCT App. No. PCT/US99/31045 (WO 00/39201 published Jul. 06, 2000) to Thomas et al., incorporated herein by reference in its entirety.

As another example, if an elastic film layer is the selected elastic member but liquid barrier properties are not particularly important or are not desired, the elastic film itself (prior to lamination) or the composite laminated with the fibrous nonwoven web may be apertured or perforated to provide a laminate capable of allowing the passage of vapors or gases. Such perforations or apertures may be performed by methods known in the art such as for example slit aperturing or pin aperturing with heated or ambient temperature pins.

Other suitable elastic materials for the elastic member include commercially available elastic stranded materials such as the spandex-type elastic threads which are available under the LYCRA® brand name from Invista North America, Wilmington, Del. Such elastic strands may be desirably arranged into a skein of substantially parallel threads or strands which run along the machine direction and are desirably spaced apart from each other across the cross machine direction at similar intervals. Such a parallel strand arrangement need not be perfectly parallel and some deviation would be expected, therefore “substantially parallel” includes a small amount of strand waviness and occasional or rare adjacent strand touching or crossover. As an alternative to commercially obtained strands, elastic strands or threads may be produced in-process instead of being unwound from a roll, by extruding an elastic polymeric composition such as described herein from a die having a series of extrusion capillaries arranged in a row. Suitable strand-forming dies include meltblowing dies as are known in the art, except that the high velocity gas streams for fiber attenuation are generally not used when forming strands. Rather, the molten polymer extrudate is pumped from the die capillaries and allowed to extend away from the die under the impetus of gravity. As mentioned above with respect to in-process production of elastic film for the elastic member 32, the material unwind roll 30 would be replaced with an elastic strand die and the newly formed elastic strands would travel over one or more chilled or quenching rollers prior to the stretching step.

Many elastomeric polymers are known to be suitable for forming the elastic member of the elastic laminate material, such as elastic fibers and strands and elastic fibrous web layers and elastic films. Thermoplastic polymer compositions may desirably comprise any elastic polymer or polymers known to be suitable elastomeric fiber or film forming resins including, for example, elastic polyesters, elastic polyurethanes, elastic polyamides, elastic co-polymers of ethylene and at least one vinyl monomer, block copolymers, and elastic polyolefins. Examples of elastic block copolymers include those having the general formula A-B-A′ or A-B, where A and A′ are each a thermoplastic polymer endblock that contains a styrenic moiety such as a poly(vinyl arene) and where B is an elastomeric polymer midblock such as a conjugated diene or a lower alkene polymer such as for example polystyrene-poly(ethylene-butylene)-polystyrene block copolymers. Also included are polymers composed of an A-B-A-B tetrablock copolymer, as discussed in U.S. Pat. No. 5,332,613 to Taylor et al. An example of such a tetrablock copolymer is a styrene-poly(ethylene-propylene)-styrene-poly(ethylene-propylene) or SEPSEP block copolymer. These A-B-A′ and A-B-A-B copolymers are available in several different formulations from Kraton Polymers U.S., LLC of Houston, Tex. under the trade designation KRATON®. Other commercially available block copolymers include the SEPS or styrene-poly(ethylene-propylene)-styrene elastic copolymer available from Kuraray Company, Ltd. of Okayama, Japan, under the trade name SEPTON®.

Elastic compositions with adhesive properties may also be formed as a blend of one or more elastic polymers with one or more tackifying resins or polymers. Tackifying resins include hydrocarbon resins derived from petroleum distillates, rosin, rosin esters, polyterpenes derived from wood, polyterpenes derived from synthetic chemicals, as well as combinations of the foregoing. Exemplary tackified adhesive-elastics include the high vicosity adhesive-elastics described in co-assigned U.S. patent application Ser. No. 10/701,259 entitled, “High-Viscosity Elastomeric Adhesive Composition”, the disclosure of which is herein incorporated by reference in its entirety. As disclosed therein, the adhesive-elastics comprise between about 50 percent and about 75. percent by weight of a base elastic polymer (such as, for example, one or more of the block copolymers mentioned above) and between about 20 percent and about 40 percent by weight of a relatively high temperature softening point tackifier (such as, for example, a tackifying resin having a softening point higher than about 176° F. (about 80° C.)) and, optionally, up to about 20 percent by weight of a low temperature softening point additive (such as, for example, tackifiers, waxes or low molecular weight resins having a softening point lower than about 176° F. (about 80° C.)), and optionally an antioxidant at about 0.1 percent to about 1.0 percent by weight.

Examples of elastic polyolefins include ultra-low density elastic polypropylenes and polyethylenes, such as those produced by “single-site” or “metallocene” catalysis methods. Such polymers are commercially available from the Dow Chemical Company of

Midland, Mich. under the trade name ENGAGE®, and described in U.S. Pat. Nos. 5,278,272 and 5,272,236 to Lai et al. entitled “Elastic Substantially Linear Olefin Polymers”. Also useful are certain elastomeric polypropylenes such as are described, for example, in U.S. Pat. No. 5,539,056 to Yang et al. and U.S. Pat. No. 5,596,052 to Resconi et al., incorporated herein by reference in their entireties, and polyethylenes such as AFFINITY® EG 8200 from Dow Chemical of Midland, Mich. as well as EXACT® 4049, 4011 and 4041 from the ExxonMobil Chemical Company of Houston, Tex., as well as blends.

Returning to FIG. 1, the extended fibrous nonwoven web 12 and elastic member 32 are directed to the nip formed between laminating rollers 46, 48 where they are positioned in face-to-face relation with one another, and directed through the nip to laminate the fibrous nonwoven web and elastic member together. The laminating rollers 46, 48 may desirably be heated bonding rollers or heated patterned point-bonding rollers as are known in the art and/or are described herein. Alternatively, the laminating rollers 46, 48 may desirably be unheated rollers which merely press the fibrous nonwoven web 12 into contact with the elastic member 32 at ambient temperature. Use of unheated laminating rollers is practical and useful where the elastic member 32 includes one or more tackified elastic compositions having adhesive properties, such as were mentioned above. An elastic member such as, for example, extruded elastic strands which includes a tackified or adhesive-elastic composition can be bonded directly to the fibrous nonwoven web due to the adhesion properties of the elastic composition.

In addition, whether the elastic member is provided as elastic strands, elastic films or elastic nonwovens, it may be desirable to bond the elastic member and fibrous nonwoven web together using an applied adhesive composition, in which case unheated laminating rollers may not be desirable or needed. Although not shown in FIG. 1, an adhesive applicator may be used to coat the surface or part of the surface of the fibrous nonwoven web 12 and/or the elastic member 32 with an adhesive composition, after the web or elastic member has exited the second pair of nipped rollers 22, 24 or fourth pair of nipped driven rollers 42, 44 and before the nonwoven web and elastic member enter the laminating rollers 46, 48. The adhesive applicator may be any suitable device as is known in the art, such as for example a melt spray adhesive applicator or a slot coat adhesive applicator, and adhesives as are known in the art may be used. It may be desirable to utilize an adhesive having at least some elastic or extensibility properties, to reduce potential restriction of the elastic properties of the elastic laminate.

After the elastic member 32 and fibrous nonwoven web 12 have been laminated together at laminating rollers 46, 48, the laminate 50 may be wound up onto material wind-up roll 52 for storage and/or transport to a product conversion facility. The laminate 50 may be rolled up in its extended state by winding the roll 52 at approximately the same linear velocity as the laminating rollers 46, 48. Alternatively, the roll 52 may have desirably have a linear velocity less than that of laminating rollers 46, 48, which allows the laminate to retract in the machine direction under the elastic recovery power of the elastic member 32. As an alternative to being rolled and stored, the laminate 50 may be directed straight away to a product conversion line.

As another alternative, the optional fifth pair of nipped driven rollers 54, 56 may be utilized to still further extend the laminate 50 in the machine direction. In this alternative, rollers 54, 56 would have a linear velocity greater than that of the laminating rollers 46, 48. Then, as above, the laminate 50 may be either rolled up in the new extended state by running roll 52 at about the same linear velocity as rollers 54, 56, or the laminate 50 may be allowed to relax just prior to roll-up by roll 52 at a lesser linear velocity than rollers 54, 56. One skilled in the art will appreciate that where one or more patterned laminating rollers is used, an extending tension on the laminate may tend to cause the patterned bond elements on a laminating roller to tear or aperture the elastic laminate material. Therefore, depending on the configuration and type of the laminating rollers, it may be more desirable for this alternative to extend the elastic laminate material between two pairs of nipped rollers (i.e. by providing another nipped driven roller pair) instead of using the lamination rollers.

As still another alternative, a second fibrous nonwoven web 62 is provided by unwinding from material unwind roll 60. The second fibrous nonwoven web 62 is directed through an extending station which includes nipped driven rollers 66, 68 with nipped driven rollers 72, 74. The second fibrous nonwoven web 62 may be any of the fibrous nonwoven web types described above with respect to first fibrous nonwoven web 12, and may be the same type of web as fibrous nonwoven web 12 or may be a different type of nonwoven web material. The nipped rollers 72, 74 may be driven at a linear velocity which is higher than nipped rollers 66, 68, in order to impart extension to the second fibrous nonwoven web 62, as was describe above with respect to the fibrous nonwoven web 12. It should be noted that the second fibrous nonwoven web 62 need not necessarily have the same level of extension as first fibrous nonwoven web 12, and, indeed may desirably not have any additional extension imparted at or by nipped rollers 72, 74. In this regard, for example, where the primary reason for adding a second fibrous nonwoven web facing layer to the elastic member is to avoid or ameliorate the tacky feel of the elastic member, the elastic member may desirably be faced with a light “dusting” of meltblown of other fibers produced from non-elastic polymer, and such light basis weight dustings of fibers may be substantially lower in basis weight, such as 5 grams per square meter (“gsm”), 3 gsm, 2 gsm or lighter. In addition, it should be noted that such a dusting or covering layer of second fibrous nonwoven web fibers may be optionally provided by direct in-line application, rather than by providing the second fibrous nonwoven web as a previously produced and unwound roll material. In any event, after the second fibrous nonwoven web 62 exits nipped rollers 72, 74 it is directed to the nip of the laminating rollers 46, 48 along with the first fibrous nonwoven web 12 and the elastic member 32. Second fibrous nonwoven web 62 is placed in face-to-face relation with the elastic member, on the side of the elastic member opposite from the first fibrous nonwoven web 12, so that the three components enter the nip of the laminating rollers 46, 48 as a sandwich or layered material having the elastic member 32 sandwiched between the two fibrous nonwoven webs.

As still another alternative, it may be desirable to provide a certain amount of reinforcement or support to the fibrous nonwoven web(s) prior to extending. By providing reinforcement to the fibrous nonwoven web, the fibrous nonwoven web may be extended to a greater extent without catastrophic failure (i.e., complete rupture or tearing of the web sheet). Exemplary reinforcement materials include melt spray adhesives as are known in the art. Such reinforcing adhesives may suitably be applied by melt spraying the reinforcement onto one or both surfaces of the fibrous nonwoven web at a time in the process prior to the fibrous nonwoven web entering the extending station defined between nipped driven rollers 16, 18 and nipped driven rollers 22, 24. Desirably, such a reinforcement adhesive may have an add-on level of about 15 gsm or less, and more suitably about 10 gsm or less, and still more suitably about 7 gsm or less. Ideally, when such a reinforcement adhesive is used, the minimum add-on level which provides suitable reinforcement is selected. In this regard, it may also be suitable for the reinforcement adhesive to be applied to the fibrous nonwoven web at an add-on level of about 5 gsm or less, or even 3 or 2 gsm or less. When such a reinforcement adhesive is used, it is desirable for its primary purpose and function to be reinforcement of the fibrous nonwoven web, rather than continuing to act as an adhesive. In this regard, melt-spray adhesives containing crystalline polyolefins, and which have a short open time at ambient temperature, are desirable. By “open time” at ambient temperature, what is meant is the time during which the reinforcement adhesive remains tacky or continues to act as an adhesive, following melt spray deposition of the reinforcement adhesive onto a substrate.

Suitable reinforcement adhesives would desirably have an open time of between about 0.2 seconds and 1 minute. Depending on the linear velocity of the fibrous nonwoven web through the elastic laminate material production process, it is more desirable for the reinforcement adhesives to have an open time between about 0.2 seconds and 3 seconds, and still more desirably the open time will be less than about 2 seconds. An exemplary reinforcement adhesive with such properties is the polypropylene-based hot melt adhesive that becomes nontacky shortly after application, described in co-assigned U.S. patent application Ser. No. 10/750,295, the disclosure of which is herein incorporated by reference in its entirety. As disclosed therein, the short open time adhesive consists of between about 15-60 percent atactic polypropylene (for example, about 39 weight percent atactic polypropylene Eastman P1023 PP, Eastman Chemical); between about 20-60 percent tackifier (for example, about 39 percent ESCOREZ 5690, from the ExxonMobil Chemical Company); between about 2-10 percent styrenic block copolymer (for example, about 5 percent VECTOR 4411 from Dexco Polymers); between about 10-20 percent isotactic polypropylene (for example, about 14 percent isotactic polypropylene PP 3746G from the ExxonMobil Chemical Company); between about 0-2 percent optional coloring agent (for example, about 2 percent of a coloring agent supplied a as a 50 percent titanium dioxide concentrate in VECTOR 4411); and finally between about 0.2-1 percent stabilizer (for example, about 0.5 percent IRGANOX 1010 from Ciba Specialty Chemicals). Other adhesives may be used with the present invention including those derived from the adhesives described in U.S. Pat. No. 6,657,009 to Zhou, and U.S. Pat. App. Publication Nos. 2002/0123538A1, 2002/0124956A1, 2002/0122953A1, and 2002/0123726A1, each of which is incorporated herein by reference in its entirety.

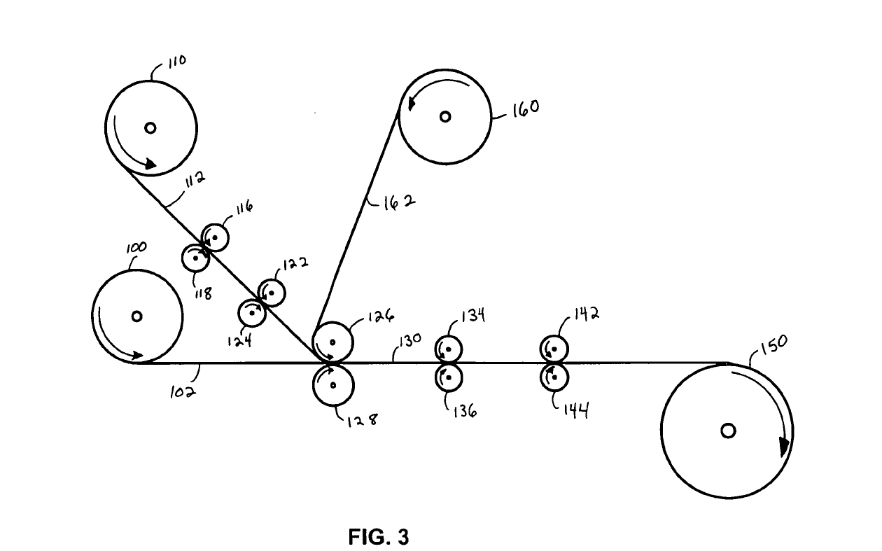

Turning to FIG. 3, there is illustrated schematically another embodiment of the process of the invention. In the process shown, a first fibrous nonwoven web 102 is provided by unwinding the fibrous nonwoven web 102 from material unwind roll 100 and is directed toward the nip formed between laminating rollers 126, 128. The fibrous nonwoven web 102 may be any suitable fibrous nonwoven web as is known in the art, such as the fibrous nonwoven webs described above with respect to FIG. 1. While the fibrous nonwoven web 102 is traveling toward the nip formed between laminating rollers 126, 128, elastic member 112 is being unwound from material unwind roll 110. The elastic member 112 is desirably an elastic film material as described above or an arrangement of elastic strands as described above. The elastic member 112 is directed through an elastic extending station which includes at least two pairs of nipped driven rollers 116, 118 and 122, 124. As is described above, the pair of nipped rollers 122, 124 is driven at a linear velocity which is greater than the linear velocity of nipped rollers 116, 118, in order to apply a machine direction tensioning force draw or extend the elastic member 112 in the machine direction. The amount of extension applied to the elastic member 112 will vary as described above with respect to FIG. 1, and other or alternative methods of providing the extension force or tension may be utilized.

The fibrous nonwoven web 102 and elastic member 112 are directed to the nip formed between laminating rollers 126, 128 where they are positioned in face-to-face relation with one another, and directed through the nip to laminate the fibrous nonwoven web 102 and elastic member 112 together. The laminating rollers 126, 128 may desirably be the heated bonding rollers or heated patterned point-bonding rollers or unheated rollers as described in the embodiment above, and the nonwoven web and elastic member may be thermally or adhesively bonded as describe above.

After the elastic member 112 and fibrous nonwoven web 102 have been laminated together at laminating rollers 126, 128, the laminate 130 is directed through an extending station which includes at least two pairs of nipped driven rollers 134, 136 and 142, 144. The pair of nipped rollers 142, 144 is driven at a linear velocity which is greater than the linear velocity of nipped rollers 134, 136, in order to apply a machine direction tensioning force draw or extend the elastic laminate 130 in the machine direction. The elastic laminate may desirably be drawn or extended to at least about 105 percent of its original length. In some situations, depending on the desired level of cloth-like attributes and desired ease of extensibility, the elastic laminate material 130 may desirably be extended to at least about 110 percent, 115 percent, 120 percent, or more of its original length. In other situations, the elastic laminate material 130 may desirably be extended to at least: about 130 percent, 140 percent, 150 percent, or even more of its original length. It should be noted that generally the laminate extending station may be desirably limited to the material travel path between roller pairs 134, 136 and 142, 144, and therefore the linear velocity of roller pair 134, 136 is desirably about the same as the linear velocity of the laminating rollers 126, 128. However, it is possible if desired to impart extension to the laminate in the material travel path defined between laminating rollers 126, 128 and roller pair 134, 136. One skilled in the art will appreciate that where one or more patterned laminating rollers is used, an extending tension on the laminate may tend to cause the patterned bond elements on a laminating roller to tear or aperture the elastic laminate material.

Following lamination and extension of the laminate, the elastic laminate material 130 may be wound up onto material wind-up roll 150 for storage and/or transport to a product conversion facility. The laminate 130 may be rolled up in its extended state by winding the roll 150 at approximately the same linear velocity as the last previous driven rollers 142, 144. Alternatively, the roll 150 may have desirably have a linear velocity less than that of rollers 142, 144, which allows the laminate to retract in the machine direction under the elastic recovery power of the elastic member 112. As an alternative to being rolled and stored, the laminate 130 may be directed straight away to a product conversion line.

As still another alternative, a second fibrous nonwoven web 162 may be provided by unwinding from material unwind roll 160. The second fibrous nonwoven web 162 may be any of the fibrous nonwoven web types described hereinabove, and may be the same type of web as fibrous nonwoven web 102 or may be a different type of nonwoven web material. The second fibrous nonwoven web 162 is directed to the nip of the laminating rollers 126, 128 along with the first fibrous nonwoven web 102 and the elastic member 112. Second fibrous nonwoven web 162 is placed in face-to-face relation with the elastic member, on the side of the elastic member opposite from the first fibrous nonwoven web 102, so that the three components enter the nip of the laminating rollers 126, 128 as a sandwich or layered material having the elastic member 112 sandwiched between the two fibrous nonwoven webs.

In the embodiments described above, the stretching or extending of the fibrous nonwoven web facings and/or of the laminate bonded nonwoven web-elastic member laminate material serves to impart a soft and cloth-like hand feel to the fibrous nonwoven web of the elastic laminate material. The extending steps loosen so-called “secondary bonds” in the nonwoven material, which may be described as fiber-to-fiber association or adhesion resulting from compaction and/or minor heat history during an initial bonding of the nonwoven into the nonwoven web, which is less than the primary bonding which takes place between the fibers at bond points, where a plurality of fibers is fused together into a film-like area. In simple terms, a “secondary bond” may be thought of as a place where the fibers are “stuck together”, but not very firmly. The extending of the fibrous nonwoven web and/or of the elastic laminate material may also break some or all of the filmed-over bond points in the fibrous nonwoven web, so that some of the fibers may be capable of moving more freely. In addition, the extension step may actually stretch some of the fibers in the fibrous nonwoven web, or portions of some of the fibers, thereby providing longer and looser sections of fibers, which can loft outward from the planar surface of the elastic laminate material, which also promotes a soft and cloth-like hand feel in the elastic laminate material.

Other methods of extending or stretching of fibrous nonwoven webs, elastic members, and elastic laminate materials exist and may be used. For example, another method for machine direction stretching of a moving web includes passing the web through a nipped pair of rollers having a gear-tooth type surface engraving, which creates channels and high points or teeth in the surfaces of the rollers which run along the longitudinal axis of the roller. It may alternatively or also be desirable to stretch/extend the fibrous nonwoven web(s), elastic members and/or the elastic laminate materials in the cross machine (transverse) direction, by such methods as tenter frames and grooved rollers. Grooved rollers may be more desirable for cross machine direction extending because nonwoven and film materials at times have a tendency to develop longitudinal tears under an applied transverse (cross machine direction) biasing or extending force. Grooved rollers may be constructed from a series of spaced disks or rings mounted on a mandrel or axle, or may be a series of spaced circumferential peaks and grooves cut into the surface of a roller; A pair of matched grooved rollers are then brought together with the peaks of one roller fitting into the grooves of the other roller, and vice versa, to form a “nip”, although it should be noted that there is no requirement for actual compressive contact as is the case for typical nipped rollers. Grooved rollers as are known in the art are described as imparting an “incremental stretching” because the whole transverse width of a web material may be stretched by what amounts to a large number of small scale stretches or increments (between each peak-to-peak distance) aligned along the transverse or cross machine direction of the web, which are less likely to cause tears than gripping the side edges of a web material and applying a stretching force to the web as a whole.

The overall level of stretching or extending performed during the process, on the components of the elastic laminate materials (fibrous nonwoven web and elastic member) or on the elastic laminate material itself, will depend on a number of factors, including desired amount of permanent deformation in the fibrous nonwoven web structure, types of polymers selected for the elastic member and fibers component, and the ability of these components to be extended without breaking catastrophically (i.e., without rupture of the entire web). Generally, the level of extending should not be so great as to exceed the maximum stretch and recovery properties of the elastic member, such that its recovery properties are largely diminished. Also, the level of extending should not be so great as to substantially destroy the fibrous nonwoven web, although some fiber breakage is acceptable and may even be desirable, in terms of additional perception of surface softness and/or surface fuzziness.

The elastic laminate materials described herein are highly suitable for use as the elastic components in a wide variety of applications, including in such products as medical and health care products such as surgical drapes, gowns and bandages, protective workwear garments such as coveralls and lab coats, and infant, child and adult personal care absorbent products such as diapers, training pants, incontinence garments and pads, sanitary napkins, wipes and the like. Other uses for the elastic laminate materials are of course possible and will be apparent to one skilled in the art. Because of the elastic construction and processing elastic laminate materials are extensible and elastic (recoverable), which can provide improved product fit and body conformance attributes, and also very soft, flexible and drapeable. Therefore these elastic laminate materials may be particularly well suited to forming gasketing elements of apparel and personal care absorbent products. Examples include waist bands, leg elastic gathers, cuff materials, and the like.

While not described in detail herein, various additional potential processing and/or finishing steps as are known in the art for processing of nonwoven web and film materials may be performed on the elastic laminate materials without departing from the spirit and scope of the invention. Examples of further processing includes such as slitting, treating, aperturing, printing graphics, or further lamination of the material with other materials, such as other films or other nonwoven layers. Specifically regarding web or laminate slitting, for example, it should be noted that it may be desirable to slit either the fibrous nonwoven web(s) or the elastic laminate material itself to some final desired slit or use-width prior to performing the laminate extension step. General examples of web material treatments include electret treatment to induce a permanent electrostatic charge in the web, or in the alternative antistatic treatments, or one or more treatments to impart wettability or hydrophilicity to a web comprising hydrophobic thermoplastic material. Wettability treatment additives may be incorporated into a polymer melt as an internal treatment, or may be added topically at some point following fiber or web formation. Still another example of web treatment includes treatment to impart repellency to low surface energy liquids such as alcohols, aldehydes and ketones. Examples of such liquid repellency treatments include fluorocarbon compounds added to the web or fibers of the web either topically or by adding the fluorocarbon compounds internally to the. thermoplastic melt from which the fibers are extruded.

### EXAMPLES

### Example 1

Elastic laminate material samples were produced substantially in accordance with the process embodiments described with respect to FIG. 1. The elastic laminate material was produced as a trilaminate or three-layered laminate having two “facings”, i.e., two fibrous nonwoven webs which were bonded to opposite sides of the elastic member. The two fibrous nonwoven webs used for facings were each spunbond-meltblown-spunbond or SMS laminate webs having a basis weight of about 0.4 ounces per square yard (osy) (about 14 grams per square meter (gsm)). The SMS webs were point-bonded (with a wire weave pattern) polypropylene materials obtained from Kimberly-Clark Corporation of Dallas, Tex. which were produced substantially in accordance with the teachings of U.S. Pat. No. 4,041,203 to Brock et al. The fibers of the spunbond layers were spun from a commercially available polypropylene resin designated 3155 polypropylene from the ExxonMobil Chemical Company of Houston, Tex. The meltblown fibers were spun from a commercially available PF-015 polypropylene, a meltblown grade polymer commercially available from Basell of Elkton, Del.

The two SMS facings were unwound and extended in the machine direction. One facing was extended by drawing the fibrous nonwoven web through two pairs of driven nipped rollers wherein the second pair of rollers were driven at approximately 115 percent of the linear velocity of the first pair of rollers, in order to produce an extension of the facings of approximately 115 percent. Specifically, the first roller pair was driven at a linear velocity of about 20.8 feet per minute (about 6.3 meters per minute) and the second roller pair was driven at a linear velocity of about 24 feet per minute (about 7.3 meters per minute). The second fibrous nonwoven web facing was extended in the machine direction in a similar fashion, except that a “first pair” or slower pair of nipped rollers was not available and so the material unwind was allowed to release the SMS material under a braking tension, such that it only released the SMS material at a rate of about 20.8 feet per minute (about 6.3 meters per minute). This way, the material unwind acted as a “slower nip” to extend the SMS facing material when used in conjunction with another nipped roller pair running at 24 feet per minute. After the SMS fibrous nonwoven webs had been extended, they were laminated to the elastic member (one facing on each side of the elastic member), which had also been extended prior to lamination.

The elastic member was provided as adhesive-property elastic strands extruded in-process and made from a mixture of an elastic styrenic block copolymer (polystyrene-poly(ethylene-butylene)-polystyrene block copolymer, commercially available from Kraton Polymers U.S., LLC of Houston, Tex. under the trade designation KRATON®)) with a tackifying resin as is described above. The adhesive elastic strands were extruded in a molten state in a substantially parallel array at a linear strand count of about 30 strands per inch of cross-machine direction width (approximately 12 strands per centimeter) and extruded onto a chilled roller to quench or cool the strands. The chilled roller was driven at a linear velocity of about 4 feet per minute (about 1.2 meters per minute) and the elastic strands were then extended to approximately 600 percent of their original machine direction length (as extruded or as-quenched length) via a stack of sequentially-faster driven rollers similar to the MDO unit shown in FIG. 2, such that the linear velocity of the final driven roller in the stack was at about 24 feet per minute (about 7.3 meters per minute). Therefore, the extended elastic member strands and the two extended SMS fibrous nonwoven webs were all traveling at approximately the same speed when the three components of the elastic laminate material entered the laminating nip in a face-to-face relation. Because the elastic member used for this example was tackified and sufficiently adhesive, the laminating nip consisted of smooth unheated rollers, and heated rollers or heated patterned bonding rollers were not necessary. Similarly, additional spray-on adhesives were not required, although additional adhesives and/or thermal bonding could be used where additional or stronger laminate bonding is desired.

After the extended fibrous nonwoven web facings and extended elastic member were laminated together, the laminate was allowed to relax under the retraction or recovery power of the elastic strands, which gathered or bunched the facings along the machine direction as the elastic strands retracted. This elastic laminate material made using SMS fibrous nonwoven web facings drawn at about 115% percent is designated example Ex1. A “control” laminate was also produced with the same SMS fibrous nonwoven web facings and the same extruded adhesive-elastic strands, except that for this control laminate material the fibrous nonwoven web facings were not extended prior to lamination with the 600 percent extended elastic strands. Samples of the elastic laminate material Ex1 qualitatively presented a softer hand feel than samples of the control material. In addition, samples of the Ex1 material presented a much fuzzier and fuller visual appearance, as well as feeling softer and fuzzier to the hand. By “fuller” visual appearance, what is meant is that the spunbond fibers in the SMS fibrous nonwoven web facing material were at least partially freed up from the wire weave bond points, in addition to freeing of spunbond fibers from secondary bonding. By secondary bonding, what is meant is fiber-to-fiber adherence at fiber cross-over points at places other than bond points, generally caused during a thermal bonding process by proximity to the heated calender rollers, but-without the high temperature and pressure experienced by the fibers of the web at the bond points.

In addition to visual and tactile performance, the elastic performance of Ex1 was compared to the control material. The ease of extensibility of materials may be compared in a manual test known as the “Unreferenced Stretch-To-Stop” or “Manual Stretch-To-Stop”. This test is a ratio determined from the difference between the unextended dimension or length of an extensible or stretchable laminate and the maximum extended dimension of the laminate (i.e. prior to tearing of the laminate) upon the application of a specified tensioning force. Stretch-to-stop may also be referred to as “maximum non-destructive elongation”. The difference between the unextended dimension of the extensible laminate and the maximum extended dimension is then divided by the unextended dimension of the stretchable laminate. If the stretch-to-stop is expressed in percent, this ratio is multiplied by 100. For example, a stretchable laminate having an unextended length of 10 centimeters and a maximum extended length of 20 centimeters after applying a manual elongation force has an unreferenced stretch-to-stop (u-STS) of 100 percent. When tested as described below, the Ex1 material had a u-STS value of 230 percent, while the control material's u-STS value was only 194%. This is an indication that the Ex1 materials, having been produced with the fibrous nonwoven web facing materials being extended prior to lamination to the elastic member, are much more extensible and easily extensible than the control material laminate.

As an example, the “Unreferenced, Stretch-To-Stop” may be measured as follows:
1. Place elastic laminate material sample on bench top in a straight line.
2. Place ruler on top of sample and slightly push on ruler in order to flatten the sample down the centerline of the sample.
3. Mark the 0 centimeter and 8 centimeter placements on the sample with a line using a permanent pen.
4. Place thumbs on the 0 centimeter and 8 centimeter lines on the sample.
5. Place left line on the 0 mark of the ruler, and stretch the right line (8 cm line) across the ruler until natural stopping point is felt. (This stopping point is where the elongation curve steepens and is easily detectable, i.e., where it becomes difficult to further elongate the sample. Stretching beyond this point will further tear the fibers of the facing material.)
6. Record the total displacement and percentage Stretch To Stop.

### Example 2

For Example 2 materials, elastic laminate material samples were produced substantially in accordance with the process embodiments described with respect to FIG. 3, wherein the fibrous nonwoven web facing or facings are not extended prior to lamination with the elastic member. The fibrous nonwoven web facings were the same polypropylene SMS materials described above with respect to Example 1, and the elastic member for each of the materials was the same adhesive-elastic strands which were made in-line by extrusion during the process. The adhesive-elastic strands were produced as described above in Example 1 and extended by MDO rolls to 600 percent of their original length, and then laminated in face-to-face relation with the un-extended SMS facing webs. One material, a control C2, was allowed to retract under the power of the elastic member strands without undergoing further extension. This control material was substantially the same as the control material described with respect to Example 1. Other material samples Ex2-A, Ex2-B, Ex2-C and Ex2-D were made which were extended while in the laminate state. The laminates were extended by use of two pairs of driven nipped rollers rotating at different linear velocities. For each Example material of Example 2, the first or slower pair of nipped rollers rotated at about 24 feet per minute (about 7.3 meters per minute) and, the second or faster pair of nipped rollers imparted the extension as follows. For Ex2-A, the second pair rotated at about 26.4 feet per minute (about 8 meters per minute) for an extension of the laminate of about 110 percent; for Ex2-B, the second pair rotated at about 28.8 feet per minute (about 8.8 meters per minute) for an extension of the laminate of about 120 percent; for Ex2-C the second pair rotated at about 30 feet per minute (about 9.1 meters per minute) for an extension of the laminate of about 125 percent; and for Ex2-D the second pair rotated at about 33 feet per minute (about 10 meters per minute) for an extension of the laminate of about 138 percent.

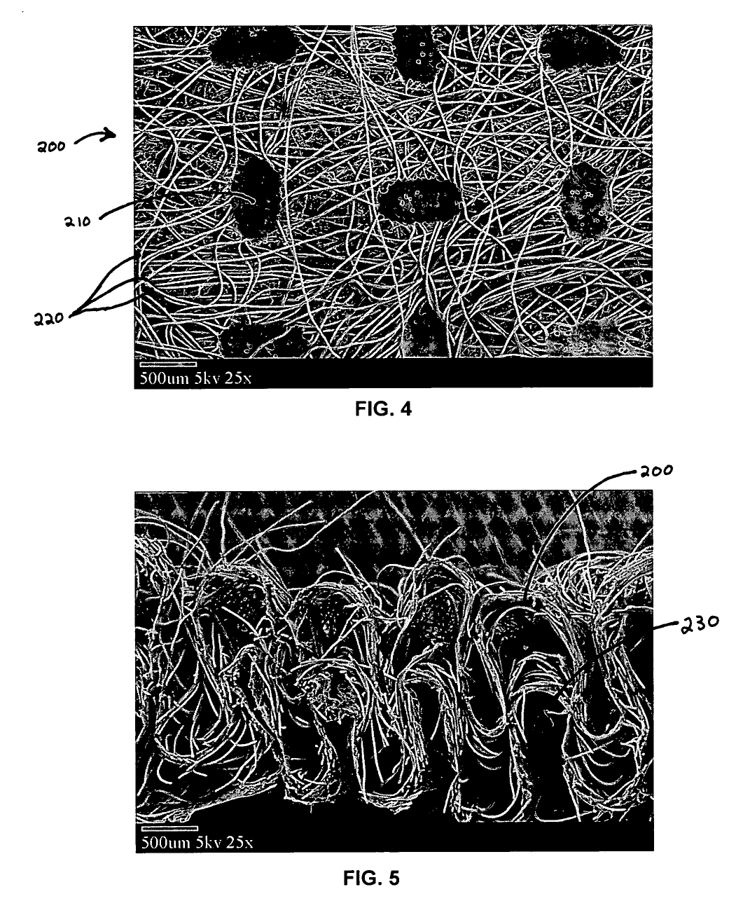

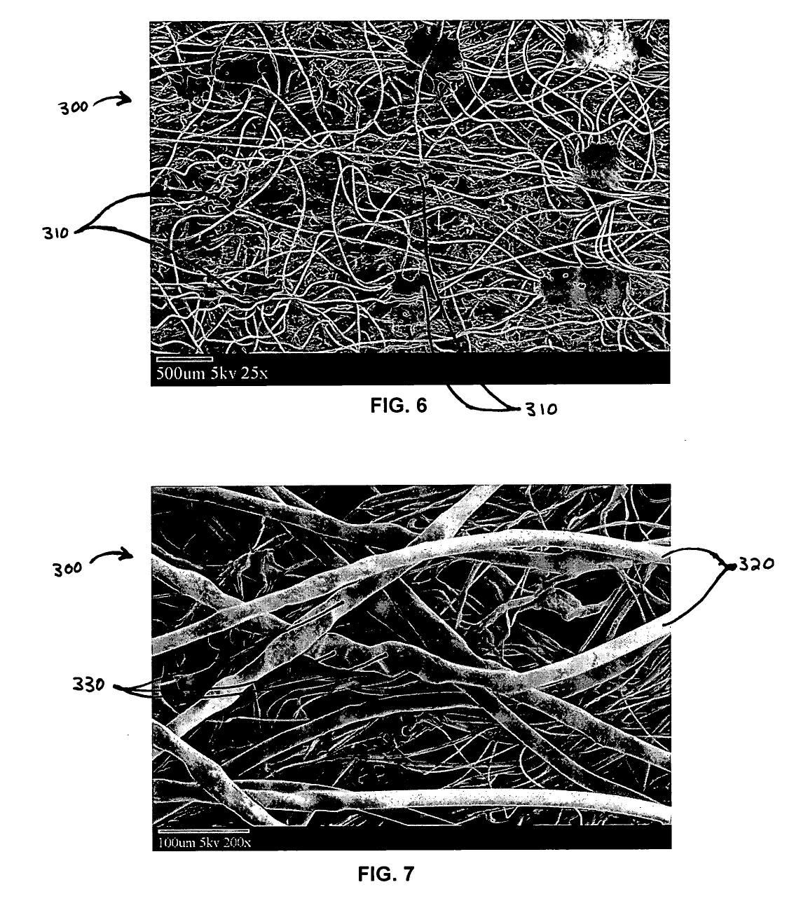

Micrographs (by scanning electron microscopy or SEM) were taken of samples of the control material C2 and of the Example material Ex2-D. In FIG. 4 and FIG. 5, one of the SMS fibrous nonwoven web facings from material C2 is shown designated as web material 200. In FIG. 4, specifically, the web material 200 is shown laid flat at 25 power, after having been removed from the laminate material. The bond points 210 of the fibrous nonwoven web can be clearly seen and are quite distinct areas wherein the fibers 220 of the fibrous nonwoven web are substantially completely fused together into a filmed-over or film-like area. FIG. 5 shows the entire comparative laminate C2 as a machine-directional cross-sectional cut wherein and fibrous nonwoven web 200 and second fibrous nonwoven web 230 are the two facings of the comparative laminate C2. As can be seen quite clearly in the photomicrograph of FIG. 5, although the two fibrous nonwoven webs 200 and 230 are gathered into undulating or puckered facing webs, each fibrous nonwoven web facing remains separate, having a quite distinct boundary layer from the other facing material, substantially throughout the viewable portion of the length of comparative material C2 shown in. FIG. 5. Turning now to FIGS. 6-9, however, one can appreciate how the elastic laminate material Ex2-D of the invention differs from the comparative material C2. For example, in FIG. 9, it is clearly seen that the two facing layers of fibrous nonwoven web 300 and 340 are nearly indistinguishable from one another, instead of being laminate layers which are clearly distance separated, as is shown in FIG. 5 for Comparative material C2.

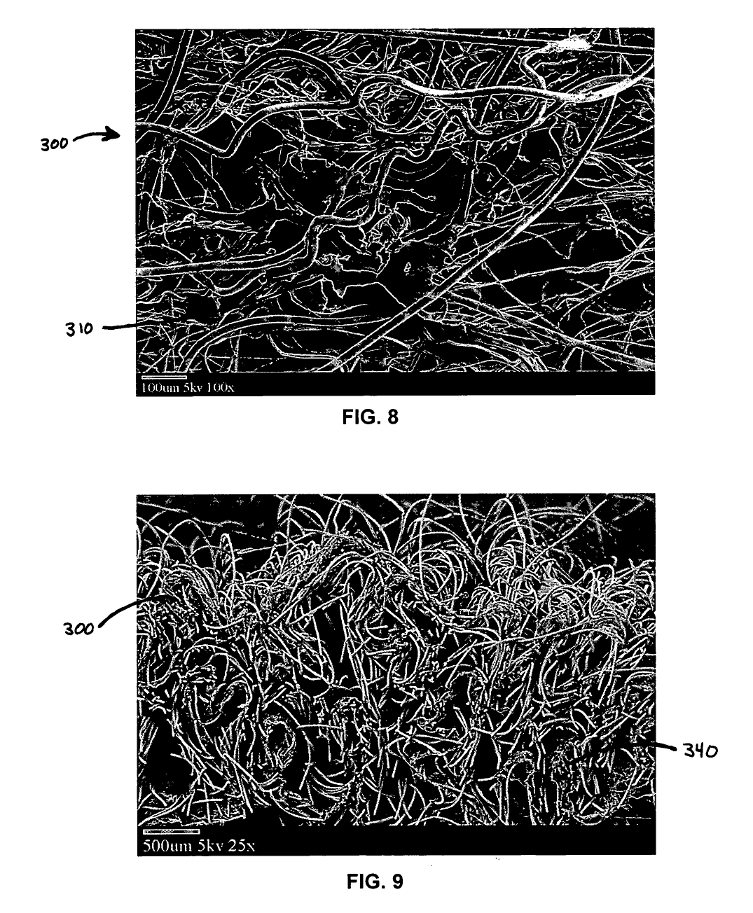

In FIG. 6 is shown a photomicrograph at 25 power of one SMS facing layer 300 of the laminate material which may be usefully compared or contrasted to the 25 power photomicrograph of comparative C2 in FIG. 4. As noted above, in FIG. 4 the bond points 210 of the fibrous nonwoven web can be clearly seen and are quite distinct and regularly shaped areas of fibers 220 fusing together, while in FIG. 6 it can clearly be seen that for fibrous nonwoven web facing web 300, the bond points 310 have been broken apart, allowing the fibers more freedom to slip past one another and otherwise move apart from one another, which tends to give the fibrous nonwoven web a softer hand feel. FIG. 8 shows much more clearly (at 100 power instead of 25 power as in FIG. 6) another broken bond point 310 in facing fibrous nonwoven web 300. Finally, FIG. 7 shows a fiber indentation phenomenon designated 330 which is clearly intermittently visible along fibers 320 which, although not wishing to be bound by theory, the inventors believe to demonstrate secondary bonding or minor fiber-to-fiber bonding at fiber cross-over points other than at bond points, and which secondary bonding has been pulled apart as a result of the elastic laminate material stretching or extending during the processing described above.

In addition to the scanning electron micrography results describe above, a Fuzz On Edge value or “FOE” was measured for the unextended Control material C2 and for elastic laminate materials of the invention which had been drawn to lengths of 110 percent, 120 percent, 125 percent and 138 percent of the original laminate length. The Fuzz On Edge value may most simply be described as an imaging analysis technique which allows for the quantification of the amount of fibers protruding upwardly or away from the x-and-y plane of a fibrous material. Generally speaking, the FOE value can be a measure of web softness inasmuch as a web having more fibers protruding upwardly from the plane of the web will feel softer to the hand than a web having a more flat fibrous aspect, i.e., having fewer fibers protruding upward. The Fuzz On Edge value may be measured as the ratio of the fiber perimeter length (the length of a fiber protruding upwardly in an arc) (in millimeters) to the material sample edge length (also in millimeters), when the material sample is bent around a beveled glass edge.

For the samples tested, a 20 centimeter long laminate sample having a width of about 5 centimeters was bent around the beveled edge and taped into place. For each sample, the fiber perimeter length and edge length were imaged and measured in 30 adjacent fields-of-view, and for each of the materials at least 6 samples were tested such that the results reported represent an average of a minimum of 180 measurements. The image analysis system used was a Quantimet 600 (Leica Inc., of Cambridge, UK) with image processing software (QWIN Version 1.06), and an image analysis program was written in Quantimet User Interactive Programming System or “QUIPS” to acquire the images, perform image processing and detection, move to the next adjacent field of view and make the FOE perimeter length/edge-length (PR/EL) measurements. The FOE measurement technique is described in more detail in European Pat. No. 0539703B1 to Hanson et al., and in U.S. Pat. No. 6,585,855 to Drew et al., both of which are incorporated herein by reference in their entireties. As can be seen in TABLE 1 below, the control (non-extended laminate) had a FOE value of 4.55. However, each of the extended elastic laminate materials had a much higher FOE value, and the FOE value generally increased with the amount of extension, indicating that higher levels of extension produce a fuzzier or softer feeling elastic laminate material.

TABLE 1

| Laminate Percent Extension | FOE (mm/mm) |
|---|---|
| Control C2 (0% extension) | 4.55 |
| 110% Extension | 5.96 |
| 120% Extension | 8.34 |
| 125% Extension | 8.28 |
| 138% Extension | 9.54 |

The extended elastic laminate materials were also tested for elastic performance to determine whether the elastic laminate materials of the invention were more extensible, or more easily extensible, than comparative laminates which had not been extended according to the process described above. As mentioned above, the ease of extensibility may be compared between materials in a manual test known as the “Unreferenced Stretch-To-Stop” or “Manual Stretch-To-Stop”. The Stretch-To-Stop value was measured as described above for the control laminate and for elastic laminate materials of the invention which were extended during the production process after lamination at 125 percent and at 138 percent. As shown in TABLE 2, the control or unextended laminate material had an unreferenced Stretch-To-Stop value of less than 200 percent, while the elastic laminate materials of the invention were much more easily extensible, having unreferenced STS values of 250 percent and 275 percent, respectively, for the laminates which were produced with additional extensions of 125 and 138 percent as described with respect to Example 2.

TABLE 2

| Laminate Percent Extension | STS (%) |
|---|---|
| Control C2 (0% extension) | 194 |
| 125% Extension | 250 |
| 138% Extension | 275 |

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

1. A process for forming an elastic laminate material, the process comprising:
providing at least one elastic member;
providing at least one fibrous nonwoven web material;
extending the at least one fibrous nonwoven web in at least one direction in an extension amount sufficient to permanently elongate the at least one fibrous nonwoven web, the at least one direction selected from the machine direction and the cross machine direction;
applying an extending force in the machine direction to the at least one elastic member to extend the at least one elastic member in the machine direction;
interposing the at least one elastic member and the at least one fibrous nonwoven web in a face-to-face relation; and
bonding the at least one elastic member and the at least one fibrous nonwoven web together to form a laminate material.

2. The process of claim 1 wherein the at least one elastic member is selected from the group consisting of elastic meltblown layers, elastic strands and elastic films.

3. The process of claim 1 wherein the at least one fibrous nonwoven web is selected from the group consisting of spunbond webs, spunbond-meltblown webs, spunbond-meltblown-spunbond webs and carded webs.

4. The process of claim 3 wherein the at least one fibrous nonwoven web comprises crimped multicomponent fibers.

5. The process of claim 1 further comprising the steps of providing a second fibrous nonwoven web and interposing the second fibrous nonwoven web in a face-to-face relation with the elastic member, on the side of the elastic member, opposite the at least one fibrous nonwoven web.

6. The process of claim 5 further comprising the step, prior to the step of interposing the second fibrous nonwoven web, of extending the second fibrous nonwoven web in at least one direction in an extension amount sufficient to permanently elongate the at least one fibrous nonwoven web, the at least one direction independently selected from the machine direction and the cross machine direction.

7. The process of claim 6 wherein the at least one fibrous nonwoven web is extended in an amount at least 10 percent greater than the amount the second fibrous nonwoven web is extended.

8. The process of claim 1 wherein the at least one direction of extending the at least one fibrous nonwoven web is the machine direction.

9. An elastic laminate material formed by the process of claim 1.

10. An elastic laminate material formed by the process of claim 5.

11. A process for forming an elastic laminate material, the process comprising:
providing an elastic member, the elastic member comprising substantially parallel elastic strand arrangements;
providing at least one fibrous nonwoven web material;
applying an extending force in the machine direction to the elastic member to extend the elastic member in the machine direction;
interposing the elastic member and the fibrous nonwoven web in a face-to-face relation;
bonding the elastic member and the fibrous nonwoven web together to form a laminate material; and
extending the laminate material in at least one direction in an extension amount sufficient to permanently elongate the at least one fibrous nonwoven web, the at least one direction selected from the machine direction and the cross machine direction.

12. The process of claim 11 wherein the elastic member strands are adhesively bonded to the fibrous nonwoven web material.

13. The process of claim 11 further comprising the steps of providing a second fibrous nonwoven web, interposing the second fibrous nonwoven web in a face-to-face relation with the elastic member on the side of the elastic member opposite the at least one fibrous nonwoven web, and bonding the at least one fibrous nonwoven web, the elastic member and the second fibrous web together to form a laminate material.

14. The process of claim 13 wherein the elastic member strands are adhesively bonded to the at least one fibrous nonwoven web and the second fibrous nonwoven web.

15. The process of claim 11 wherein during the step of extending the laminate material the extension amount is at least 115 percent of the unstretched laminate dimension.

16. An elastic laminate material formed by the process of claim 11.

17. An elastic laminate material formed by the process of claim 13.

18. An elastic laminate material comprising at least one elastic member and at least one fibrous nonwoven web bonded together in face-to-face relation, the fibrous nonwoven web having on at least one surface thereof a short open time reinforcement adhesive in an amount less than about 10 grams per square meter.

19. The elastic laminate material of claim 18 wherein the at least one elastic member is selected from the group consisting of elastic meltblown, elastic strands and elastic films.

20. The elastic laminate material of claim 18 wherein the at least one fibrous nonwoven web is selected from the group consisting of spunbond webs, spunbond-meltblown webs, spunbond-meltblown-spunbond webs and carded webs.

21. The elastic laminate material of claim 18 further comprising a second fibrous nonwoven web bonded in face-to-face relation with the elastic member on the side of the elastic member opposite the at least one fibrous nonwoven web.

22. The elastic laminate material of claim 18 wherein at least one of the fibrous nonwoven webs comprises crimped multicomponent fibers.
